(19) United States
(12) Patent Application Publication
(10) Pub. No.: US 2008/0245139 A1
(43) Pub. Date: Oct. 9, 2008

(54) SCANNING PROBE MICROSCOPE AND MEASUREMENT METHOD OF SAME

(76) Inventors: Takafumi Morimoto, Tsuchiura-shi (JP); Toru Kurenuma, Tsuchiura-shi (JP); Manabu Edamura, Tsuchiura-shi (JP); Hiroshi Kuroda, Tsuchiura-shi (JP); Yukio Kembo, Tsuchiura-shi (JP); Masahiro Watanabe, Tsuchiura-shi (JP); Shuichi Baba, Tsuchiura-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/061,308

(22) Filed: Apr. 2, 2008

(30) Foreign Application Priority Data
Apr. 3, 2007 (JP) 2007-097680

(51) Int. Cl. G01B 5/28

(52) U.S. Cl. 73/105

(57) ABSTRACT

A measurement method of a scanning probe microscope including a first approach operation adjusting an operation position of a fine positioning unit to near a maximum extension amount and ending the approach by coarse positioning, a first measurement operation making the probe scan the surface for measurement in a close probe state based on the first approach operation to obtain relief information of the sample surface, a positioning operation positioning the probe at a recessed part based on the relief information obtained by the first measurement operation, a second approach operation making the probe again approach the surface at a position determined by the positioning operation, adjusting an operation position of the Z-axis fine positioning device to close to a maximum extension amount, and ending the repeated approach, and a second measurement operation making the probe scan the surface for measurement in a close probe state based on the second approach operation to obtain relief information of the sample surface.

### BACKGROUND OF THE INVENTION

1. Field of the Invention

The present invention relates to a scanning probe microscope and measurement method of the same, more particularly relates to technology for effective utilization of an extension amount of a fine positioning device for finely changing the height position of a probe in the height direction with respect to a sample surface when using a probe to scan fine relief shapes on a sample surface for measurement.

2. Description of the Related Art

In measurement of a sample surface by a conventional scanning probe microscope, a coarse positioning mechanism is operated to make the probe approach and stop at the sample surface. At that time, the amount of displacement (extension amount or retraction amount) of a Z-axis fine positioning device is adjusted to change the height position of the probe with respect to the sample surface (Japanese Patent Publication (A) No. 2002-323425). In this case, right after the probe approach, the general practice has been to adjust the position to near the intermediate position of the range of change, that is, near about 50% of the maximum extension amount, so that the possibility rises of unknown projecting parts or recessed parts present on the unmeasured sample surface both falling in the range of displacement by the Z-axis fine positioning device.

Referring to FIG. 6A and FIG. 6B, the approach operation of a probe and probe scan operation after approach by a conventional scanning probe microscope, that is, a measurement operation by a scanning probe microscope, will be explained.

FIG. 6A and FIG. 6B show the state where a sample 104 formed with recessed parts 102 and projecting parts 103 on the surface 101 is measured by scanning the surface 101 by a probe 105. At the surface 101 of the sample 104, recessed parts 102 and projecting parts 103 are repeatedly formed in a certain direction. This is called a “line and space pattern”. The “line and space pattern” means a lattice pattern of line parts (projecting parts 103) and grooves or spaces (recessed parts 102) alternately repeating as 3D shapes.

FIG. 6A shows an example of movement in the case where the initial approach position of the probe 105 is a projecting part 10, while FIG. 6B shows an example of movement where the initial approach position of the probe 105 is a recessed part 102.

The line and space patterns measured by scanning probe microscopes are in general of widths of the micron order (μm) to the submicron order. Furthermore, in samples processed by the latest semiconductor production processes, in dimensions, the widths become less than 100 nm. With such fine line width samples, controlling the initial probe approach position to a projecting part or to a recessed part is difficult. For this reason, it is unclear if the probe approaches a projecting part or approaches a recessed part. In the example of the sample 104 shown in FIG. 6A and FIG. 6B, for example, the step difference is 3 μm and the maximum extension amount of the Z-axis fine positioning device 106 for making the probe 105 finely move in the height direction is 10 μm.

In the example shown in FIG. 6A, the extension amount of the Z-axis fine positioning device 106 at the time of the end of approach in the state with the probe 105 approaching the projecting part 103 is adjusted to for example 50% of the maximum extension amount. If starting the scan of the probe 105 as shown by the arrow mark (path of scan movement) 107 in this state, there is room for operation by 5 μm above and by 5 μm below in movement of the probe 105 in the height direction. In FIG. 6A, the position of operation 5 μm above, that is, the position where the Z-axis fine positioning device 106 is completely retracted, is shown as 0%, while the position of operation 5 μm below, that is, the position where the Z-axis fine positioning device 106 is extended to the maximum, is shown as 100%. The position of 0% to the position of 100% becomes the measurable range 108. According to the example of scan movement of the probe 105 in the case of FIG. 6A, the position of the base surfaces of the recessed parts 102 of the depth of 3 μm is in the range of operation of the Z-axis fine positioning device 106, that is, the measurable range 108, so as shown by the path of scan movement 107, it is possible to measure the relief shapes of the surface of the sample 104 without problem.

Further, as clear from the path of scan movement 107 of the probe 105 shown in FIG. 6B, even when the probe 105 approaches the base surface of a recessed part 102, the probe 105 can move in the measurable range 108 and measurement can similarly be performed without problem.

In the measurement method according to the conventional scanning probe microscope, consider the case, referring to FIG. 6A and FIG. 6B, where for example the maximum extension amount of the Z-axis fine positioning device is 10 μm and the step difference of the relief shapes formed on the surface of the sample 104 is 9 μm. The step differences of the relief shapes are smaller than the maximum extension amounts of the Z-axis fine positioning device, so originally should be able to be measured. FIG. 7A and FIG. 7B, in the same way as FIG. 6A and FIG. 6B, show longitudinal cross-sectional views of line and space patterns of repeated recessed parts 102 and projecting parts 103 on the surface of the sample 104.

In the example shown in FIG. 7A, in the same way as the case of FIG. 6A, the probe 105 is made to approach a projecting part 103 and the extension amount of the Z-axis fine positioning device 106 when ending the approach is adjusted to 50% of the maximum extension amount. If starting the scan of the probe 105 in this state, there is room for operation 5 μm above and 5 μm below in movement of the probe 105 in the height direction. As a result, the path of scan movement 109 occurs. However, the step difference of the relief shapes of the sample 104 is 9 μm, so there is only room for operation by 5 μm below. As shown by the path of movement 109, the probe 105 cannot reach the base parts of the recessed parts 102. Accordingly, the problem arises that it is not possible to accurately measure the recessed parts 102 down to the base parts.

Further, in the example shown in FIG. 7B, in the same way as the case of FIG. 6B, the extension amount of the Z-axis fine positioning device 106 at the time when the probe 105 approaches a recessed part 102 and finishes the approach is adjusted to 50% of the maximum extension amount. Even when starting the scan of the probe 105 in this state, there is room for operation by 5 μm above and by 5 μm below in terms of movement in the height direction of the probe 105. However, the relief shapes of the sample 104 have a step difference of 9 μm, so above there is only room for operation by 5 μm. As shown by the path of scan movement 110, the probe 105 cannot reach a position exceeding the topmost parts of the projecting parts 103. Therefore, it is not possible to accurately measure up to the top parts of the projecting parts 103. In the worst case, a problem arises in that the probe 105 or sample 104 ends up being damaged.

In the above way, according to the method of probe approach and the method of scan movement of a conventional scanning probe microscope, cases end up occurring where measurement is not possible even if making the maximum extension amount of the Z-axis fine positioning device larger than the step difference of the relief shape parts of the sample 104.

### SUMMARY OF THE INVENTION

An object of the present invention is to provide a scanning probe microscope and measurement method of the same able to suitably adjust the approach position of the probe and the extension amount of the Z-axis fine positioning device at the time of end of the approach operation at the time of measurement of relief shapes of the sample surface and effectively utilize the extension amount to measure even relief shapes with step differences slightly smaller than the maximum extension amount.

The scanning probe microscope and its measurement method according to the present invention is configured as follows to achieve this object.

The first measurement method of a scanning probe microscope is a method comprising a first approach operation making a probe approach a sample surface by coarse positioning control, adjusting an operation position of a Z-axis fine positioning device to close to a maximum extension amount, and ending the approach by coarse positioning, a first measurement operation making the probe scan the surface for measurement in a close probe state based on the first approach operation to obtain relief information of the sample surface, a positioning operation positioning the probe at a recessed part based on the relief information obtained by the first measurement operation, a second approach operation making the probe again approach the surface at a position determined by the positioning operation, adjusting an operation position of the Z-axis fine positioning device to close to a maximum extension amount, and ending the repeated approach, and a second measurement operation making the probe scan the surface for measurement in a close probe state based on the second approach operation to obtain relief information of the sample surface.

A second measurement method of a scanning probe microscope is a method comprising a first approach operation making a probe approach a sample surface by coarse positioning control, adjusting an operation position of a Z-axis fine positioning device to close to a maximum extension amount, and ending the approach by coarse positioning, a first measurement operation making the probe scan the surface for measurement in a close probe state based on the first approach operation to obtain relief information of the sample surface, a positioning operation positioning the probe at a projecting part based on the relief information obtained by the first measurement operation, a second approach operation making the probe again approach the surface at a position determined by the positioning operation, adjusting an operation position of the Z-axis fine positioning device to close to a minimum extension amount, and ending the repeated approach, and a second measurement operation making the probe scan the surface for measurement in a close probe state based on the second approach operation to obtain relief information of the sample surface.

A third measurement method of a scanning probe microscope comprises the first method further preferably performing processing for judging if there is a region where the probe cannot reach the sample surface in the first measurement operation and performing a positioning operation for determining a position of the probe in the region when there is such a region, performing the second approach operation at the position according to the positioning operation and then performing the second measurement operation, and then again repeating the judgment processing and repeating the second approach operation and the second measurement operation until there is no longer any region where the probe cannot reach the sample surface

A fourth measurement method of a scanning probe microscope comprises the above methods further preferably making the probe retract once to return to a state where the probe does not contact the sample surface after the first measurement operation and the second measurement operation.

A fifth measurement method of a scanning probe microscope comprises the above methods preferably further including a third approach operation adjusting an extension amount of the Z-axis fine positioning device and ending the approach of the probe so as to obtain the optimum extension amount based on the relief information obtained by the second measurement operation and a third measurement operation making the probe scan the surface for measurement in a close probe state based on this third approach operation to obtain relief information of the sample surface.

A sixth measurement method of a scanning probe microscope is a method comprising a first approach operation making a probe approach a sample surface by coarse positioning control, adjusting an operation position of a Z-axis fine positioning device to near a maximum extension amount, and ending the approach by coarse positioning and a first measurement operation making the probe scan the surface in a close probe state based on the first approach operation for measurement to obtain relief information of the sample surface.

A first scanning probe microscope is comprised of a probe, a Z-axis fine positioning device changing a height position of the probe with respect to a sample, a coarse positioning mechanism making the probe approach or retract from the sample, a first detecting means for detecting a physical quantity acting between the probe and the surface of the sample, a first control means for making the Z-axis fine positioning device extend or retract to adjust the distance between the probe and sample so that the detection value output from this first detecting means matches with a target value, and a second control means for controlling the approach and retraction operations of the coarse positioning mechanism, detecting the physical quantity by the first detecting means, maintaining operational control of the Z-axis fine positioning device using the first control means, and in that state making the probe approach the sample by the coarse positioning mechanism and adjusting an extension amount of the Z-axis fine positioning device to near a maximum extension amount based on the control of the approach-retraction operation of the coarse positioning mechanism by the second control means at the time of end of this approach operation.

The second scanning probe microscope is comprised of the above wherein further preferably an extension amount of the Z-axis fine positioning device at the time of end of the approach is 95% of the maximum extension amount. According to the scanning probe microscope or its measurement method of the present invention, the approach position of the probe and the extension amount of the Z-axis fine positioning device at the time of the end of the approach operation at the time of measurement of the relief shapes of the sample surface are suitably adjusted in accordance with the relief of the sample surface, so it is possible to effectively utilize the extension amount of the Z-axis fine positioning device to measure even relief shapes of step differences slightly smaller than the maximum extension amount.

### BRIEF DESCRIPTION OF THE DRAWINGS

The above object and features of the present invention will become clearer from the following technology of the preferred embodiments given with reference to the attached drawings:

FIG. 1 is a view of the configuration showing an embodiment of a scanning probe microscope according to the present invention,

FIGS. 2A, 2B, and 2C are views showing states of movement of a probe in the region of relief shape parts of a sample surface,

FIG. 3 is a flow chart showing a routine of control relating to movement of a probe,

FIG. 4 is a flow chart showing a routine of other control relating to movement of a probe,

FIG. 5 is a flow chart showing a routine of still other control relating to movement of a probe,

FIGS. 6A and 6B are views for explaining a first example of conventional probe movement, and

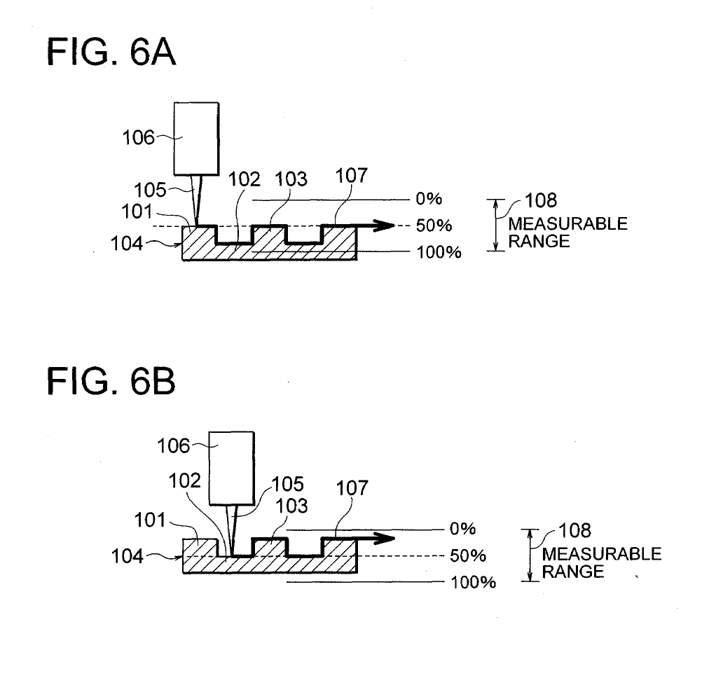

FIGS. 7A and 7B are views for explaining a second example of conventional probe movement.

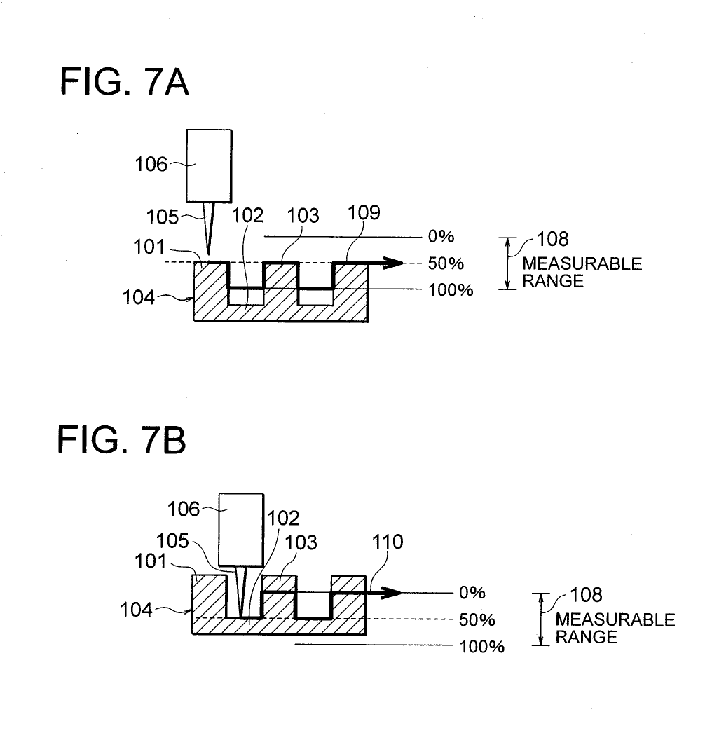

### DESCRIPTION OF THE PREFERRED EMBODIMENTS

Below, preferred embodiments of the present invention will be explained based on the attached drawings.

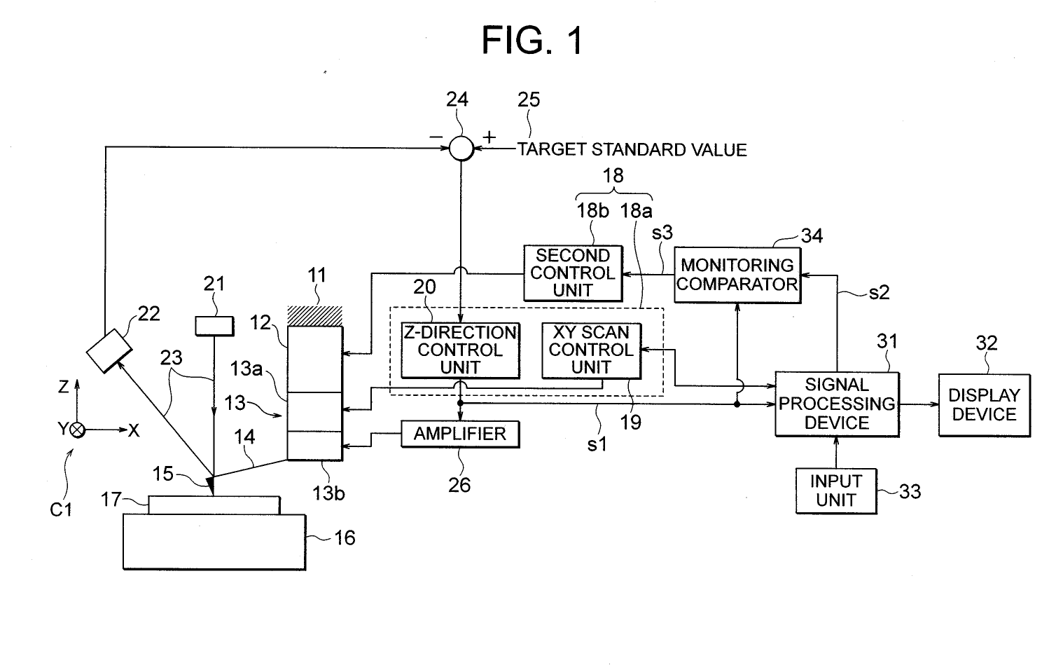

Referring to FIG. 1, one example of the configuration of a scanning probe microscope according to an embodiment of the present invention will be explained. This scanning probe microscope is for example an atomic force microscope. In this embodiment, the explanation is given with respect to an example of an atomic force microscope, but the scanning probe microscope to which the present invention is applied is not limited to this.

In the atomic force microscope shown in FIG. 1, a coarse positioning mechanism unit 12 is fastened to a fastening part 11 provided on a support frame (not shown). At the bottom part of the coarse positioning mechanism unit 12, a fine positioning mechanism unit 13 is attached. At the bottom end of the fine positioning mechanism unit 13, the base end of a cantilever 14 is fastened, whereby the cantilever 14 is attached. At the front end of the cantilever 14, a probe 15 is formed. Below the cantilever 14, a sample 17 placed on a sample table 16 is arranged. The probe 15 has a sharp tip. This tip faces the surface of the sample 17 in the state close to the surface.

FIG. 1 shows three mutually perpendicular axes, that is, a 3D coordinate system C1 comprised of an X-axis, Y-axis, and Z-axis. The Z-axis is perpendicular to the surface of the sample 17, while the Z-axis direction (or Z-direction) becomes the height direction with respect to the sample surface. The XY plane formed by the X-axis and Y-axis becomes a plane parallel to the sample surface.

The coarse positioning mechanism unit 12 is a positioning mechanism used for movement of the probe 15 in the height direction with respect to the surface of the sample 17 for an approach or retraction operation of the probe 15. Further, the coarse positioning mechanism unit 12 includes a mechanism for scan movement of the probe 15 in the XY plane direction as well over a relatively large distance. At the initial period of the start of measurement, the coarse positioning mechanism unit 12 is used for an operation making the probe 15 approach the sample surface.

For the coarse positioning mechanism unit 12, for example, a piezoelectric actuator or positioning mechanism designed for coarse positioning is used. In the case of the latter positioning mechanism, the coarse positioning mechanism unit 12 is comprised of a ball-screw mechanism or other drive mechanism. Note that the coarse positioning mechanism 12 can be provided at the sample table 16 side.

The fine positioning mechanism unit 13 is a positioning mechanism for movement of the probe 15 in 3D directions (X-axis, Y-axis, and Z-axis directions) by relatively small distances. The fine positioning mechanism unit 13 is comprised of an XY fine positioning unit 13a for scan movement of the probe 15 in the surface direction (XY direction) of the sample 17 and a Z-fine positioning unit 13b for movement of the probe 15 in the height direction (Z-direction). The fine positioning mechanism unit 13 is usually configured utilizing a piezoelectric actuator. A tube type fine positioning device or tripod type fine positioning device etc. is used.

The operations of the coarse positioning mechanism unit 12 and fine positioning mechanism unit 13 are controlled by the control apparatus 18. Furthermore, the control apparatus 18 is provided with a first control unit 18a controlling the operation of the fine positioning mechanism unit 13 and a second control unit 18b controlling the operation of the coarse positioning mechanism unit 12. Furthermore, the first control unit 18a is comprised of an XY scan control unit 19 controlling the operation of the XY fine positioning unit 13a and Z-direction control unit 20 controlling the operation of the Z-fine positioning unit 13b. The control apparatus 18 is comprised of a computer or controller. The operations of the coarse positioning mechanism unit 12 and fine positioning mechanism unit 13 are controlled in accordance with a measurement program put together based on a preplanned measurement routine and stored in a memory of a computer etc.

The cantilever 14 is provided with an optical lever type optical system displacement detection device for detecting the displacement occurring due to deflection of the cantilever 14. The optical lever type displacement detection device is comprised of a laser generator (laser beam source or laser generator) 21 emitting a laser beam 23 striking a back surface of the cantilever 14 and a photo detector 22 receiving the laser beam 23 reflected at the back surface of the cantilever 14. Illustration of the power supply for activating the laser generator 21 or photo detector 22 is omitted. If deflection occurs at the cantilever 14, the incident position of the laser beam on the light receiving surface of the photo detector 22 changes, whereby the displacement occurring at the cantilever 14 can be detected. Note that to detect the displacement of the cantilever 14, the optical interference method, piezoresistance method, etc. may also be used.

The detection signal relating to the displacement of the cantilever 14 output from the photo detector 22 is input to a comparator (or subtractor) 24. In the comparator 24, a separately set target standard value 25 is set and input. The comparator 24 finds the difference between the target standard value 25 and the value according to the detection signal and inputs the difference signal to the Z-direction control unit 20 of the first control unit 18a of the control apparatus 18. The Z-direction control unit 20, in the same way as the conventional case, performs the well known comparison-integral compensation control processing and generates and outputs a control signal. The output control signal is given through an amplifier 26 to the Z-fine positioning unit 13b of the fine positioning mechanism unit 13. Based on the control signal given from the Z-direction control unit 20, the Z-direction extension/retraction operation of the Z-fine positioning unit 13b is controlled and the amount of displacement due to the extension/retraction is determined. Due to the loop comprised of the optical lever type position detection mechanism, comparator 24, and Z-direction control unit 20, a feedback control system is formed for making the amount of deformation of the cantilever 14 the target standard value 25.

When making the probe 15 positioned above the sample 17 approach the surface of the sample 17, the coarse positioning mechanism unit 12 is operated and thereby the cantilever 14 moves downward. When the probe 15 approaches the surface of the sample 17 by a predetermined distance, an atomic force acts between the surface of the sample 17 and the probe 15 and deflection occurs in the cantilever 14. The deflection of the cantilever 14 is detected by the optical lever type optical system displacement detection device comprised of the laser generator 21 and photo detector 22. The laser beam 23 emitted from the laser generator 21 strikes the back surface of the cantilever 14, then strikes the light receiving surface of the photo detector 22.

According to this configuration, when the cantilever 14 deforms, the photo detector 22 detects the displacement of the probe 15 in the Z-direction. The position information of the probe 15 in the height direction detected by the photo detector 22 is compared by the comparator 24 with a preset target standard value 25. A signal of the difference is input to the Z-direction control unit 20 in the first control unit 18a. The Z-direction control unit 20 generates a signal controlling the operation of the Z-fine positioning unit 13b of the fine positioning mechanism unit 13 and gives it to the Z-fine positioning unit 13 based on the information relating to the difference input so that the height position (clearance between sample and probe) of the probe 15 with respect to the sample surface becomes a standard position set by a target standard value 25. Based on the above feedback control, the atomic force between the sample and probe is held constant and the distance between the sample and probe is held constant.

According to this configuration, if giving the scan control signal from the XY scan control unit 19 of the first control unit 18a of the control apparatus 18 to the XY fine positioning unit 13a of the fine positioning mechanism unit 13, scanning the surface of the sample 17, and setting the height position of the probe 15 with respect to the sample surface to the predetermined position given by the target standard value 25 based on the height position control system of the cantilever 14, the probe 15 moves along the shape of the sample surface and acquires the height information of the sample surface (information of relief shapes), whereby the surface shape of the sample 17 can be measured.

The surface shape of the sample 17 is measured specifically by fetching the control signal s1 output from the Z-direction control unit 20 into the signal processing device 31 and storing it in the memory. The signal processing device 31 combines the height information of the sample surface based on the control signal s1 and the scan range information relating to the XY scan prepared in advance, prepares an image in the measurement range, and displays this on the screen of the display device 32. Note that the signal processing device 31 is formed by a computer in the same way as the control apparatus 18. In this illustrated example, the signal processing device 31 and the control apparatus 18 are shown separately for convenience in the explanation, but may also be configured as a single computer of course. The signal processing device 31 is provided with a keyboard, mouse, or other input unit 33.

In this configuration, a monitoring comparator 34 is further provided. The monitoring comparator 34 receives as input the target displacement amount as the command signal s2 for determining the amount of displacement of the Z-fine positioning unit 13b from the signal processing unit 31 and the control signal s1 output from the Z-direction control unit 20. The target displacement amount from the signal processing device 31 is usually given by an operator through an input unit 33.

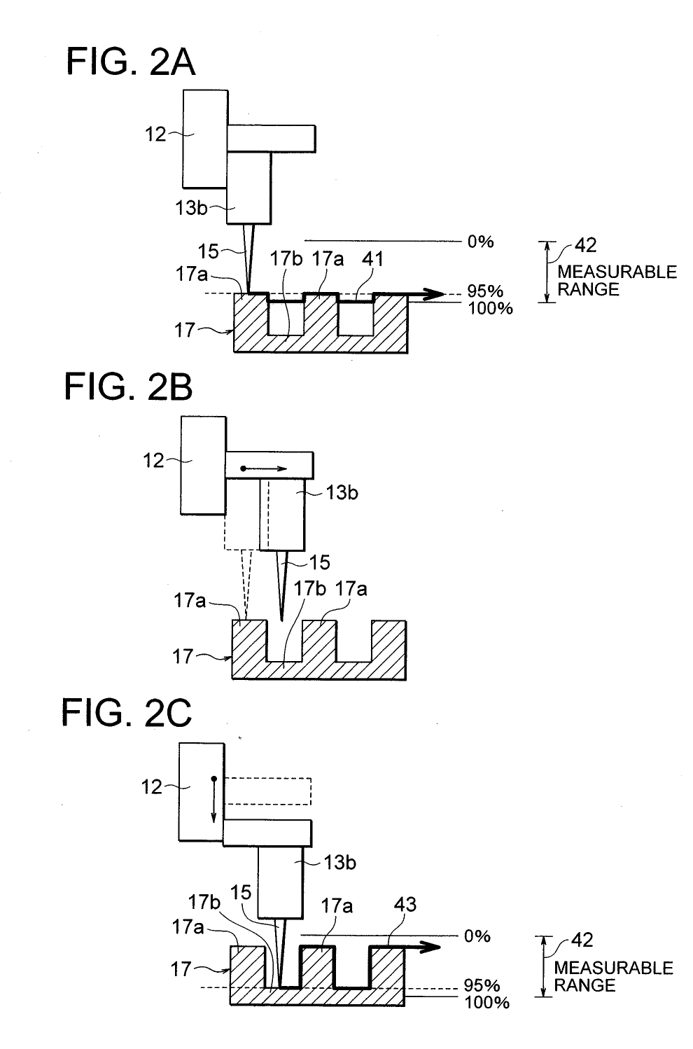

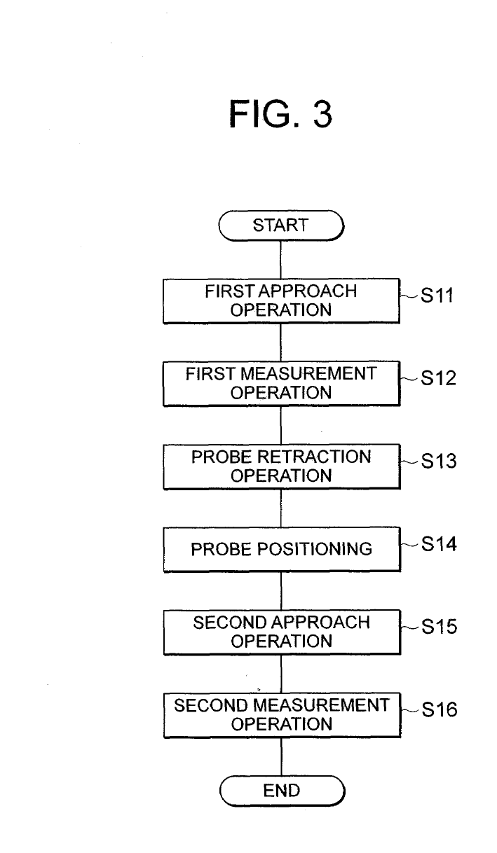

Next, referring to FIG. 2A to 2C and FIG. 3, the approach operation of the probe 15 and the probe scan operation after approach (measurement operation) at the time of applying the measurement method according to an embodiment in the scanning probe microscope having the above configuration will be explained.

The operation state shown in FIGS. 2A, 2B, and 2C shows an example of operation in the case where the first approach operation is at the top surface of a projecting part, while FIGS. 2A to 2C show changes in the state along with the elapse of time.

Note that in FIGS. 2A to 2C, for convenience in explanation, part of the sample 17, the probe 15, the Z-fine positioning unit 13b, and the coarse positioning mechanism unit 12 are shown. In the sample 17, relief shape parts comprised of projecting parts 17a and recessed parts 17b are shown. In this case, the step differences of the relief shape parts are assumed to be smaller than the maximum extension amount of the Z-fine positioning unit 13b. Further, FIG. 3 shows a flowchart of an approach/scan movement of the probe 15 for working the measurement method according to the present embodiment.

The probe 15 is originally at a position above the surface of the sample 17. The coarse positioning mechanism unit 12 makes the probe 15 move downward. Note that the probe 15 is formed at the front end of the cantilever 14. In FIG. 2, illustration of the cantilever 14 is omitted. At this time, the feedback control system comprised of the Z-direction control unit 20 is held in an active state. That is, control of the Z-fine positioning unit 13b by the Z-direction control unit 20 (control for making the physical quantity constant) is continued. In this state, based on the second control unit 18b, the Z-direction coarse positioning mechanism unit 12 makes the probe 15 approach the surface of the sample 17. Simultaneously, the monitoring comparator 34 monitors the signal s1 relating to the control instruction values output from the Z-direction control unit 20.

When a specific physical quantity (atomic force) is detected between the probe 15 and the sample 17, in conventional approach control, the operation of the approach movement of the probe 15 by the coarse positioning mechanism unit 12 is stopped, but in the probe approach control according to the present embodiment, the monitoring comparator 34 compares the control signal from the Z-direction control unit 20 and the target displacement amount and gives a control instruction signal s3 to the second control unit 18b so that the two match. As a result, the second control unit 18b controls the approach operation (or retraction operation) by the coarse positioning mechanism unit 12 based on this control instruction signal s3. Since the Z-direction control unit 20 controls the Z-direction extension/retraction operation of the Z-fine positioning unit 13b, even after the probe 15 substantially contacts the surface of the sample 17, the approach operation of the probe 15 by the coarse positioning mechanism unit 12 is continued with the physical quantity controlled constant as it is, and the Z-fine positioning unit 13b gradually retracts (or extends). When the amount of displacement of the Z-fine positioning unit 13b changes, this is taken out from the control signal s1 output from the Z-direction control unit 20, and it is judged that this matches with the target displacement amount given by the monitoring comparator 34, the monitoring comparator 34 outputs a signal for stopping the control operation to the second control unit 18b. In this way, the approach operation of the probe 15 is stopped and the amount of displacement of the Z-fine positioning unit 13b is controlled to the desired displacement amount. In that state, the positioning of the probe at the sample surface is completed.

According to the probe positioning method at the time of approach of the probe 15, the target displacement amount given to the monitoring comparator 34 can be freely given by an operator from the input unit 33, so it is possible to freely control and freely adjust the amount of displacement of the Z-fine positioning unit 13b at the time when the probe is stopped.

In this way, it is possible to freely adjust the stroke (extension amount or displacement amount) of the Z-fine positioning unit 13b in the approach and stopping of the probe 15. Therefore, in the case of this embodiment, as shown in FIG. 2A, the probe is stopped near the maximum extension amount, preferably an extension amount of 95% of the maximum extension amount (step S11 of first approach operation).

In the state of FIG. 2A, the tip of the probe 15 approaches the top part of a projecting part 17a of the surface of the sample 17 and the extension amount (stroke) of the Z-fine positioning unit 13b at the time of the end of the approach of the probe is made 95% of the maximum extension amount.

Next, in the state shown in FIG. 2A, as shown by the path of movement 41, the first measurement operation is performed to obtain information relating to the relief shapes on the surface of the sample 17 (step S12). The first measurement operation is performed by the XY fine positioning unit 13a and the Z-fine positioning unit 13b based on the probe scan operation in the XY direction. In FIG. 2A etc., the range shown by reference numeral 42 shows the measurable range.

After the first measurement operation ends, the probe 15 is made to retract once from the surface of the sample 17 (step S13). This retraction operation is performed by the coarse positioning mechanism unit 12. However, this retraction operation is not necessarily required and may be omitted.

Based on the information of the relief shapes of the sample surface obtained by the first measurement operation, the positioning operation by the XY fine positioning unit 13a positions the probe 15 at the position of the initial recessed part 17b (step S14). This state is shown in FIG. 2B.

Next, again, in the state shown in FIG. 2B, the coarse positioning mechanism unit 12 makes the probe 15 approach the recessed part 17b and, in the same way as the above case, adjusts the extension amount of the Z-fine positioning unit 13b to 95% of the maximum extension amount and performs the second approach operation (step S15). The state after the second approach operation is shown in FIG. 2C.

In the state after the second approach operation is completed, the tip of the probe 15 contacts the base surface of a recessed part 17b. In this state, the probe 15 is made to scan the surface in the XY direction to execute the second measurement operation (step S16). This state is shown by the path of movement 43 in FIG. 2C.

Due to the above operation, it is possible to use a Z-fine positioning unit 13b with for example a maximum extension amount of 10 μm to measure relief shapes with step differences of 9 μm.

In the measurement method, the example of the case where the first approach operation of the probe 15 (step S11) just happens to be performed with respect to the top part of a projecting part 17a was explained, but even if the first approach operation happens to be performed with respect to the base part of a recessed part 17b, the operation starts from the step S16 (state shown in FIG. 2C), so the second approach operation (step S15) becomes unnecessary. In this case, the first measurement operation (step S12) can measure and observe the relief shapes of the surface of the sample 17.

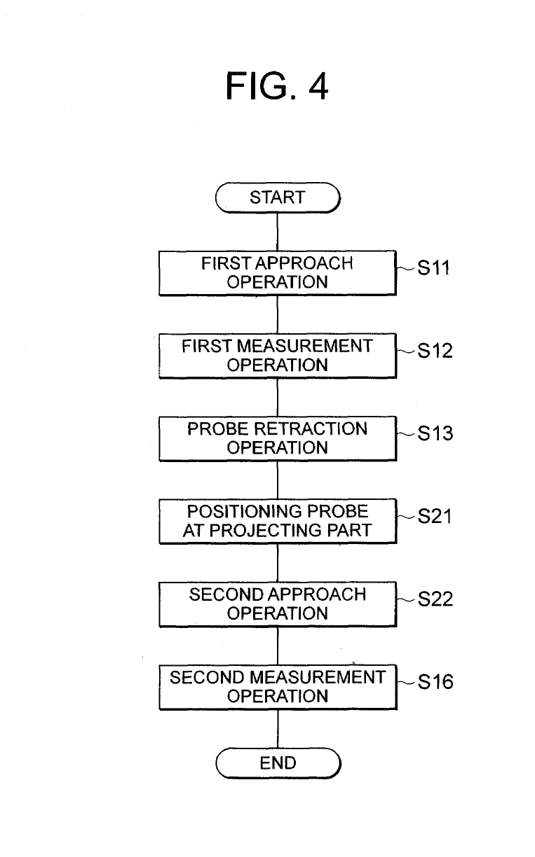

Further, the measurement method can be changed as shown in the flowchart of FIG. 4. In FIG. 4, steps the same as the steps shown in FIG. 3 are assigned the same reference notations and detailed explanations are omitted.

In this measurement method, after the first approach operation of step S11 and the first measurement operation of step S12, the probe 15 is positioned at the position of the first projecting part 17a by the positioning operation by the XY fine positioning unit 13a based on information of the relief shapes of the sample surface obtained (step S21).

Further, next, again, the coarse positioning mechanism unit 12 makes the probe 15 approach a projecting part 17a to perform a second approach operation (step S22). In this case, unlike the case of the first approach explained above, the extension amount of the Z-fine positioning unit 13b is adjusted to near the minimum extension amount, for example 5%, and the second approach operation is executed (step S22). After the second approach operation, the above-mentioned second measurement operation (step S16) is performed.

According to the measurement method, the scan by the probe 15 is started smoothly and swiftly and the sample surface can be measured from the projecting part 17a side at the relief shapes at the surface of the sample 17.

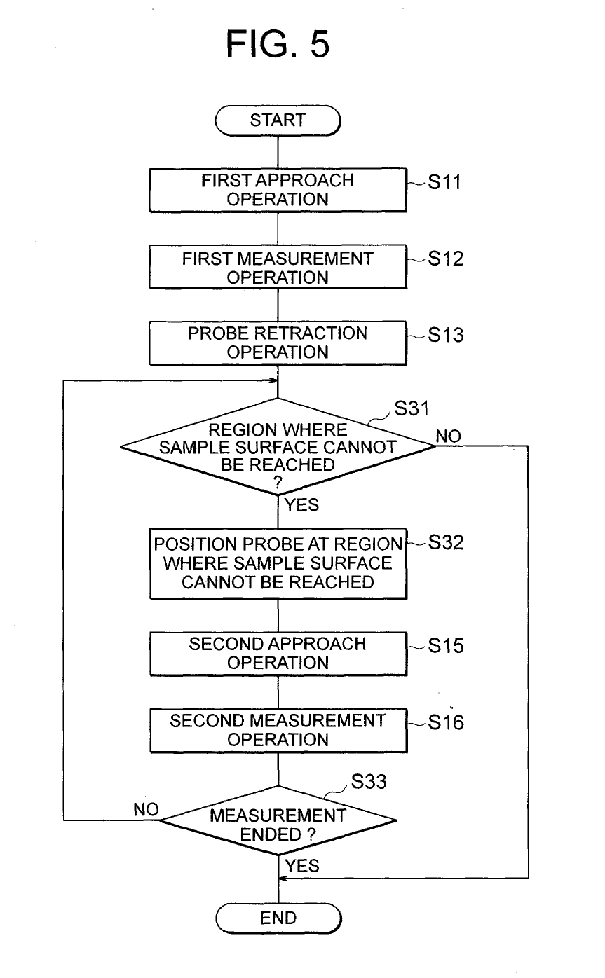

Furthermore, the routine of the measurement method explained based on FIG. 3 may be changed as shown in the flowchart of FIG. 5. In FIG. 5, steps the same as the steps shown in FIG. 3 are assigned the same reference numerals and detailed explanations are omitted.

Steps S11 to S16 are as explained above. In this measurement method, steps S31, S32, and S33 are added. At step S31, processing is performed for judging if there is a region where the probe 15 cannot reach the sample surface based on the information of the relief shapes of the sample surface obtained by the first measurement operation (step S12). When there is a region where the probe 15 cannot reach the sample surface (case of YES at judgment step S31), the positioning operation by the XY fine positioning unit 13a performs the positioning operation for positioning the probe 15 in that region (step S32).

After the step S32, the approach operation is started for the recessed parts etc. of the region, the extension amount of the Z-fine positioning unit 13b is adjusted to for example 95% of the maximum extension amount, and the second approach operation is performed (step S15). In that state, a second measurement operation is performed (step S16).

Next, when the judgment at step S33 judging whether to end measurement is NO, the routine returns to the judgment step S31 where it is again judged if there is a region where the probe 15 cannot reach the sample surface based on the information of relief shapes of the sample surface obtained by the second measurement operation. Note that the standard for forcibly ending the measurement is separately suitably set.

Due to the second measurement operation, when there is a region where the probe 15 cannot reach the base of the recessed parts 17b, the steps S32, S15, and S16 are repeated. When the judgment at the judgment step S31 is NO or the judgment at the judgment step S33 is YES, the measurement operation is ended.

According to the measurement method, when making the probe 15 scan the surface and execute the measurement operation, there is the advantage that if it were not possible to obtain accurate shape information on the base parts of the recessed parts 17b, the approach operation and scan operation for obtaining the information on the shapes of the base parts of the recessed parts 17b are repeated the required number of times until there is no longer any region where the probe cannot reach the sample surface.

Furthermore, the measurement method may be comprised of an approach operation (third approach operation) adjusting the extension amount of the Z-fine positioning unit 13b to become the optimum extension amount and ending the approach of the probe 15 based on the relief information obtained from the second measurement operation (step S16) and a third measurement operation making the probe 15 scan the surface for measurement in the close probe state based on this approach operation and obtain relief information of the sample surface.

The configurations, shapes, sizes, and positional relationships explained in the above embodiments are only shown in a simplified manner to an extent enabling understanding and working of the present invention. Therefore, the present invention is not limited to the explained embodiments and can be modified in various ways without departing from the scope of the technical ideas disclosed in the claims.

The present disclosure relates to the main matter included in Japanese Patent Application No. 2007-097680 filed on Apr. 3, 2007 and incorporates the entire disclosed content by reference.

1. A measurement method of a scanning probe microscope including:
a first approach operation making a probe approach a sample surface by coarse positioning control, adjusting an operation position of a Z-axis fine positioning device to close to a maximum extension amount, and ending the approach by coarse positioning,
a first measurement operation making said probe scan the surface for measurement in a close probe state based on said first approach operation to obtain relief information of said sample surface,
a positioning operation positioning said probe at a recessed part based on said relief information obtained by said first measurement operation,
a second approach operation making said probe again approach the surface at a position determined by said positioning operation, adjusting an operation position of said Z-axis fine positioning device to close to a maximum extension amount, and ending the repeated approach, and
a second measurement operation making said probe scan the surface for measurement in a close probe state based on said second approach operation to obtain relief information of said sample surface.

2. A measurement method of a scanning probe microscope including:
a first approach operation making a probe approach a sample surface by coarse positioning control, adjusting an operation position of a Z-axis fine positioning device to close to a maximum extension amount, and ending the approach by coarse positioning,
a first measurement operation making said probe scan the surface for measurement in a close probe state based on said first approach operation to obtain relief information of said sample surface,
a positioning operation positioning said probe at a projecting part based on said relief information obtained by said first measurement operation,
a second approach operation making said probe again approach the surface at a position determined by said positioning operation, adjusting an operation position of said Z-axis fine positioning device to close to a minimum extension amount, and ending the repeated approach, and
a second measurement operation making said probe scan the surface for measurement in a close probe state based on said second approach operation to obtain relief information of said sample surface.

3. A measurement method of a scanning probe microscope as set forth in claim 1, further comprising
performing processing for judging if there is a region where said probe cannot reach said sample surface in said first measurement operation and performing a positioning operation for determining a position of said probe in said region when there is such a region,
performing said second approach operation at the position according to said positioning operation and then performing said second measurement operation, and
then again repeating said judgment processing and repeating said second approach operation and said second measurement operation until there is no longer any region where said probe cannot reach said sample surface.

4. A measurement method of a scanning probe microscope as set forth in claim 1 further comprising making said probe retract once to return to a state where said probe does not contact said sample surface after said first measurement operation and said second measurement operation.

5. A measurement method of a scanning probe microscope as set forth in claim 1, further including
a third approach operation adjusting an extension amount of said Z-axis fine positioning device and ending the approach of said probe so as to obtain the optimum extension amount based on said relief information obtained by said second measurement operation and
a third measurement operation making said probe scan the surface for measurement in a close probe state based on this third approach operation to obtain relief information of said sample surface.

6. A measurement method of a scanning probe microscope including
a first approach operation making a probe approach a sample surface by coarse positioning control, adjusting an operation position of a Z-axis fine positioning device to near a maximum extension amount, and ending the approach by coarse positioning and
a first measurement operation making said probe scan the surface in a close probe state based on said first approach operation for measurement to obtain relief information of said sample surface.

7. A scanning probe microscope comprised of a probe, a Z-axis fine positioning device changing a height position of the probe with respect to a sample, a coarse positioning mechanism making the probe approach or retract from the sample, a first detecting means for detecting a physical quantity acting between the probe and the surface of the sample, a first control means for making the Z-axis fine positioning device extend or retract to adjust the distance between the probe and sample so that the detection value output from this first detecting means matches with a target value, and a second control means for controlling the approach and retraction operations of the coarse positioning mechanism,
detecting said physical quantity by said first detecting means, maintaining operational control of said Z-axis fine positioning device using said first control means, and in that state making said probe approach said sample by said coarse positioning mechanism and
adjusting an extension amount of said Z-axis fine positioning device to near a maximum extension amount based on the control of the approach-retraction operation of said coarse positioning mechanism by said second control means at the time of end of this approach operation.

8. A scanning probe microscope as set forth in claim 7, wherein an extension amount of said Z-axis fine positioning device at the time of end of the approach is 95% of the maximum extension amount.
